(19) United States
(12) Patent Application Publication
(10) Pub. No.: US 2019/0338541 A1
(43) Pub. Date: Nov. 7, 2019

(54) TRACTION SUPPORT APPARATUS

(71) Applicant: Jamey Ryan Williams, Farmington, MN (US)

(72) Inventor: Jamey Ryan Williams, Farmington, MN (US)

(21) Appl. No.: 16/400,944

(22) Filed: May 1, 2019

Related U.S. Application Data
(60) Provisional application No. 62/665,193, filed on May 1, 2018.

(51) Int. Cl. E04G 3/26; E04G 1/32; F16M 11/22

(52) U.S. Cl. CPC E04G 3/26; F16M 2200/08; F16M 11/22; E04G 1/32

(57) ABSTRACT

A traction support apparatus for stability on a surface includes a base layer, a pad coupled to the base layer configured to engage a surface, and a riser selectively attachable to the base layer. The traction support apparatus may further include a locking slot on the base layer to slidably engage the riser.

### CROSS-REFERENCE TO RELATED APPLICATION

This application is a non-provisional application which claims priority to U.S. provisional application No. 62/665,193, filed on May 1, 2018, the content of which are incorporated herein by reference in its entirety.

### BACKGROUND

The present disclosure is related to traction support apparatus. More specifically, the present disclosure is related to traction support apparatus for use on a surface.

A traction support apparatus is a device that may be placed on a surface, such as a relatively level surface or an inclined surface to provide stability and footing support for a user or materials. Inclined surfaces may include a roof, hill, or other sloped surfaces. For example, sloped roofs may provide difficult surfaces to work safely and efficiently on, and carry the risk that workers, equipment, or other materials may slip and cause injury or damage. An inclined surface such as a roof may also be at risk of damage from a worker or materials due to improper weight distribution.

### SUMMARY

This Summary and Abstract are provided herein to introduce a selection of concepts in simplified form that are further described below in the Detailed Description. The Summary and Abstract are not intended to identify key features or essential features of the claimed subject matter, nor are they intended to be used as an aid in determining the scope of the claimed subject matter. The claimed subject matter is not limited to the implementations that solve any or all the disadvantages noted in the background.

A support apparatus of the disclosure may include a base layer, a pad coupled to the base layer configured to engage a surface, and a riser selectively attachable to the base layer.

In another embodiment of the disclosure, a support apparatus may include a base layer with a plurality locking slots, a pad coupled to the base layer, and a plurality of risers slidably detachable from the plurality of locking slots.

A method includes providing a base layer with a forward end and a rear end coupled to a pad, engaging a slidably detachable riser to the base layer, and frictionally engaging the pad to a surface. Other features and benefits that characterize embodiments of the disclosure will be apparent upon reading the following detailed description and review of the associated drawings.

### BRIEF DESCRIPTION OF THE DRAWINGS

FIG. 1 illustrates a perspective view of a support apparatus according to an embodiment of the present disclosure.

FIG. 2 illustrates a side view of a support apparatus according to an embodiment of the present disclosure.

FIG. 3 illustrates a top view of a support apparatus according to an embodiment of the present disclosure.

### DETAILED DESCRIPTION

Although the present disclosure has been described with reference to preferred embodiments, workers skilled in the art will recognize that changes may be made in form and detail without departing from the scope of the disclosure.

Working on inclined or sloped surfaces can pose many problems due to the risk of slipping or sliding down the inclined surface. This problem may be encountered on a variety of inclined surfaces such as a roof, hill, sidewalk, or other surfaces. For example, slipping when repairing a roof may pose a danger to those involved, including those on the roof and those nearby or beneath. Slipping also poses a risk of danger to materials or equipment. Other risks may include damage to the roof and surrounding property due to improper weight distribution or damage from unsecured equipment.

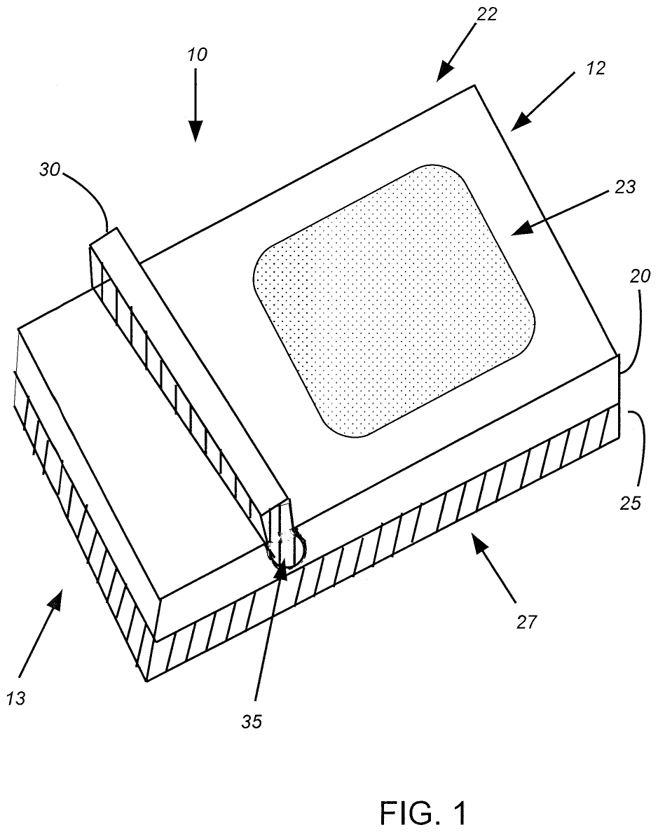

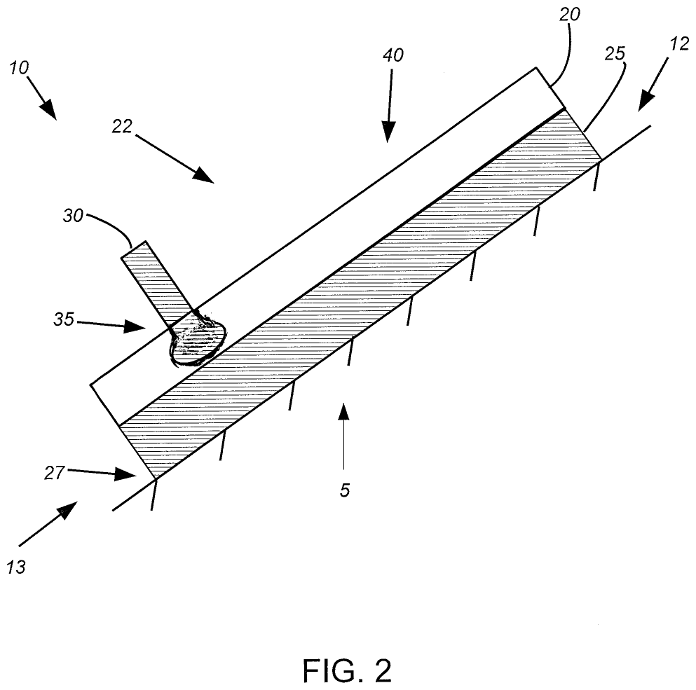

FIG. 1 illustrates a perspective view of a support apparatus according to an embodiment of the present disclosure. A support apparatus 10 may be employed to distribute weight and provide stability and footing support on a surface 5 (see FIG. 2). Surface 5 may include a generally level surface, or a slopped or inclined surface, such as a roof or hill. Support apparatus 10 includes a forward end 12 which may be positioned on an upward or higher portion of surface 5, and a rear end 13 which may be positioned on a downward or lower portion of the surface 5. Support apparatus 10 includes a base 20 coupled to a pad 25. A bottom surface of base 20 may be coupled to a top surface of pad 25. Base 20 may be coupled to pad 25 by a variety of applications, such as adhesives, screws, or other fastening means. A traction element 23 may be included on a top surface 22 of base 20. Support apparatus 10 may be positioned such that when pad 25 is placed on surface 5, a bottom surface 27 of pad 25 is frictionally engaged with the surface 5. Base 20 includes a groove or slot 35 running laterally on the top surface 22 of base 20 to provide a locking slot for a step or arm 30. Arm 30 crosses base 20 laterally to provide a step or riser on support apparatus 10 to enable greater stability and footing on a surface 5. Arm 30 may include a pin or rail correspondingly shaped to slot 35 which is configured to be selectively attached or secured to base 20 or selectively detached from base 20. Arm 30 may be selectively attached by sliding the rail of arm 30 laterally along slot 35 in base 20 in a tongue and groove manner. Arm 30 is configured to slidably engage slot 35 and provides a step extending upwards from base 20 to enable improved footing support and provide a back stop on support apparatus 10.

FIG. 2 illustrates a side view of support apparatus 10 placed on surface 5. Support apparatus 10 comprising base 20 coupled to pad 25 is positioned on surface 5 to provide stability and footing support. Here, the forward end 12 of support apparatus 10 is on the upward portion of surface 5 and rear end 13 is on the lower portion of surface 5. As can be seen, the bottom surface 27 of pad 25 is in contact with surface 5. Direction arrow 40 illustrates a downward force being applied on support apparatus 10, such as by a user, equipment, or other means. When downward force is applied, support apparatus 10 is configured to remain in position due to the pad 25 being in frictional engagement with surface 5. One feature of using frictional engagement is that support apparatus 10 may be quickly and easily placed or repositioned on surface 5 without using more severe securing methods, such by nailing an apparatus to the surface 5.

Arm 30 may be selectively attached to base 20 by slidably engaging arm 30 with slot 35 and provides further traction and support to support apparatus 10 as a step or back stop. The rail of arm 30 may be inserted into slot 35 running laterally in base 20 to provide a user greater traction and support when in use. Arm 30 may also be selectively attached for other purposes. For example, arm 30 provides a back stop and may be used to prevent equipment or other material from sliding off of support apparatus 10 when on an inclined surface 5. Slot 35 is illustrated as substantially circular to provide a locking slot for the correspondingly shaped rail of arm 30, however, slot 35 may comprise alternative shapes to slidably engage arm 30. For example, arm 30 and slot 35 may include a correspondingly shaped pin and tail arrangement with various angles, such as a dovetail design, to enable arm 30 to slidably engage slot 35 and remain in a secure position when in use. Arm 30 may also be formed in a variety of shapes to provide traction and support on a surface 5. In one example, arm 30 is substantially flat such that it is extends perpendicular from top surface 22 of base 20 when slidably engaged. In another example, arm 30 may be sloped at an angle from base 20. In another example, arm 30 may include curved features. For example, a top portion of arm 30 may be angled toward forward end 12 when the arm 30 is slidably engaged with base 20. Although support apparatus 10 is illustrated with a single slot 35 and a single arm 30, the apparatus need not be so limited, and support apparatus 10 may include a plurality of slots and or a plurality of arms to provide various traction support options when using support apparatus 10 on a surface.

In alternative embodiments, support apparatus 10 may comprise different shapes and sizes. Although base 20 and pad 25 have been illustrated as roughly similar in thickness and proportion, these are merely representational and therefore are not drawn to scale. In one embodiment, base 20 may include a tapered feature. For example, base 20 may have a tapered thickness from the rear end 13 to the forward end 12 such that rear end 13 has a greater thickness than the forward end 12. In this example, the greater thickness of rear end 13 may provide additional structure and support for arm 30. Further, support apparatus 10 has been illustrated as roughly rectangular in shape but embodiments need not be so limited. Support apparatus 10 may be provided in a variety of shapes or include alternative features, such as rounded edges. Other features may include extended or widened surfaces of base 20 at the rear end 13 or at the forward end 12, to provide greater surface area for traction and support on the surface 5. For example, support apparatus may be wider at the forward end 12 than at the rear end 13 to provide greater surface area for a user, equipment, or other materials when on a surface 5.

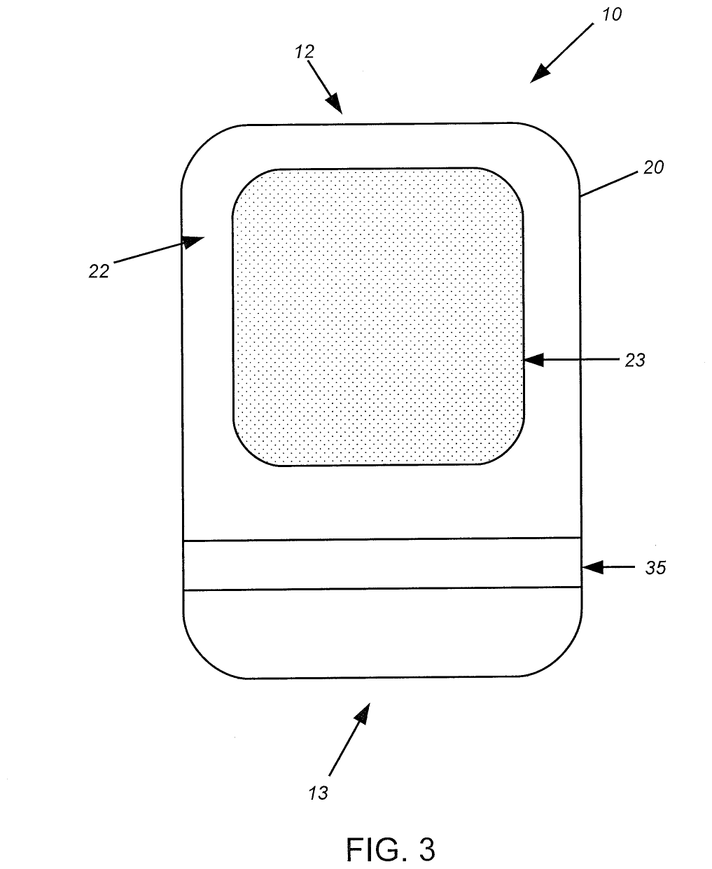

FIG. 3 illustrates a top view of an embodiment of support apparatus 10. As can be seen, base 20 includes traction element 23 on the top surface 22 of base 20. In this illustration arm 30 is removed and slot 35 is provided in base 20 laterally from side to side of support apparatus 10. Arm 30 may be selectively detachable and attachable to base 20 to provide greater flexibility of use. For example, arm 30 may be removed to provide a larger surface area, such as for large or bulky materials, or when the surface 5 has a less severe incline. Arm 30 may also be removed for storage or transportation purposes. In other instances, greater traction support may be desired, and arm 30 may be attached to provide a step or back stop for a user or materials. FIG. 3 illustrates traction element 23 covering a major portion of the top surface 22 from slot 35 towards the top or forward end 12. However, the embodiment need not be so limited, and traction element 23 may be provided on more or less of support apparatus 10 without departing from the scope of the disclosure.

Support apparatus 10 may include a variety of materials to provide strength and durability. Materials may also be used to provide strength with reduced weight. Pad 25 may be formed of a foam pad. However, a variety of materials may be used for pad 25 to provide resilience and cushioning when providing frictional engagement with surface 5. Base 20 provides a firm surface and may be formed with a variety of materials to provide rigidity and strength. In one example, base 20 is formed of glass reinforced plastic, but other materials may be used, such as wood, plywood, metal, or plastic. Traction element 23 may also be provided by various means. In one example, traction element 23 includes a non-skid sheet coupled to top surface 22 of base 20. In another example, top surface 22 may include raised or roughened features to provide traction element 23 on base 20.

As described, support apparatus 10 includes a base layer, a pad coupled to the base layer to engage a surface, and a riser selectively attachable to the base layer. Support apparatus 10 may be used by placing pad 25 in contact with surface 5, e.g., an inclined surface. The forward end 12 may be placed on the upper or higher side of surface 5 and the rear end 13 may be placed on the lower side of surface 5. A riser, e.g., arm 30 may be slidably engaged with slot 35 depending on user preferences and surface incline conditions. In another embodiment of the disclosure, a support apparatus may include a base layer with a plurality locking slots, a pad coupled to the base layer, and a plurality of risers slidably detachable from the plurality of locking slots.

A method of using the support apparatus as described may include providing a base layer with a forward end and a rear end coupled to a pad, engaging a slidably detachable riser to the base layer, and frictionally engaging the pad to an inclined surface.

Although support apparatus 10 has been described for use on surface 5 such as a sloped roof, one skilled in the art will recognize that support apparatus 10 may be used on a variety of surfaces where a user or material could benefit from traction support. Although the present disclosure has been described with reference to embodiments, workers skilled in the art will recognize that changes may be made in form and detail without departing from the scope of the disclosure. This disclosure is illustrative only and changes may be made in detail in matters of structure, arrangement, and methods without departing from the scope of the present disclosure.

What is claimed is:

1. A support apparatus comprising:
a base layer;
a pad coupled to the base layer configured to engage a surface; and
a riser selectively attachable to the base layer.

2. The support apparatus of claim 1, and further comprising a locking slot on the base layer to slidably engage the riser.

3. The support apparatus of claim 1, and further comprising a traction element on a top surface of the base layer.

4. The support apparatus of claim 1, and wherein the base layer provides a rigid surface.

5. The support apparatus of claim 1, and wherein the base layer includes a tapered forward end.

6. The support apparatus of claim 1, and wherein the base layer is formed of glass reinforced plastic.

7. The support apparatus of claim 1, and wherein the pad is configured to engage the surface through frictional engagement.

8. The support apparatus of claim 1, and wherein the pad comprises a foam pad.

9. A support apparatus comprising:
a base layer with a plurality of locking slots;
a pad coupled to the base layer; and
a plurality of risers slidably detachable from the plurality of locking slots.

10. The support apparatus of claim 9, and further comprising a traction element on a top surface of the base layer.

11. The support apparatus of claim 9, and wherein the base layer provides a rigid surface.

12. The support apparatus of claim 9, and wherein the base layer includes a tapered forward end.

13. The support apparatus of claim 9, and wherein the base layer is formed of glass reinforced plastic.

14. The support apparatus of claim 9, and wherein the pad is configured to engage a surface through frictional engagement.

15. The support apparatus of claim 9, and wherein the pad comprises a foam pad.

16. A method of using a support apparatus comprising:
providing a base layer with a forward end and a rear end coupled to a pad;
engaging a slidably detachable riser to the base layer; and
frictionally engaging the pad to a surface.

17. The method of claim 16, and further comprising providing a locking slot in the base layer to engage the slidably detachable riser.

18. The method of claim 16, and wherein the base layer includes a traction element.

19. The method of claim 16, and further comprising providing a downward force to frictionally engage the pad to the surface.

20. The method of claim 16 and further comprising forming the base layer with reinforced plastic.
